(19) United States
(12) Patent Application Publication
(10) Pub. No.: US 2011/0162031 A1
(43) Pub. Date: Jun. 30, 2011

(54) APPARATUS FOR GENERATING MULTI VIDEO

(76) Inventors: Jong-Chul Weon, Seoul (KR); Hyung-Jin Roh, Gyeonggi-Do (KR); Jae-Kwon Jeong, Gyeonggi-Do (KR)

(21) Appl. No.: 12/652,971

(22) Filed: Jan. 6, 2010

(30) Foreign Application Priority Data
Dec. 24, 2009 (KR) 2009-0130923
Dec. 24, 2009 (KR) 2009-0130927

(51) Int. Cl. H04N 7/08; H04N 7/16

(52) U.S. Cl. 725/137; 725/138

(57) ABSTRACT

A multi video generation apparatus is provided to transmit partial videos to a multivision. The multi video generation apparatus generates partial videos from a video, and transmits the generated partial videos to displays connected thereto. In the multi video generation apparatus, the number of video transmission modules for transmitting the video to the connected display may be changed according to a content of a multi video to be displayed on the display. Therefore, it is possible to generate more diverse types of multi video which a user desires to display on a multivision.

### CROSS-REFERENCE TO RELATED APPLICATIONS

This application claims priority from Korean Patent Application Nos. 10-2009-0130923 and 10-2009-0130927, filed on Dec. 24, 2009 in the Korean Intellectual Property Office, the disclosures of which are incorporated herein by reference in their entirety.

### BACKGROUND OF THE INVENTION

1. Field of the Invention

The present invention relates to a multivision system, and more particularly, to a multivision system which combines a plurality of displays to display a single video.

2. Description of the Related Art

Multivisions that have been treated merely as artwork become widespread as a result of the falling prices of displays and an increase in visual entertainment. Accordingly, users can meet multivisions not only in public places, such as airports, stations or sports grounds, but also in streets.

Thus, there is a need for methods to generate more diverse types of video which users desire to display using multivisions that are being increasingly used.

Additionally, multivisions divide a received video into a plurality of partial videos, and display the plurality of partial videos. Partial videos are generated by a multivision, so if a user desires to change partial videos, he or she needs to move to a location where the multivision is installed, which causes inconvenience to a manager of the multivision.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide a multi video generation apparatus which generates more diverse types of multi video which a user desires to display using a multivision.

According to an aspect of the present invention, there is provided a multi video generation apparatus including a video provider which provides a video, and at least one video transmission module which generates a partial video from the video provided by the video provider, and transmits the generated partial video to a display connected thereto.

The at least one video transmission module may extract different portions of the video provided by the video provider, may generate different partial videos, and may transmit the generated partial videos to different displays connected thereto.

A first video transmission module among the at least one video transmission module may extract a first portion of the video provided by the video provider, may generate a first partial video, and may transmit the generated first partial video to a first display. Additionally, the first video transmission module may extract a second portion of the video provided by the video provider, may generate a second partial video, and may transmit the generated second partial video to a second display.

A second video transmission module among the at least one video transmission module may generate a partial video from a first video provided by the video provider, may transmit the generated partial video to a third display, and may transmit a second video provided by the video provider to a fourth display.

The second video may be a video representing predetermined information with text.

The first video may be one of a broadcast video, a prestored video, a video received from an external device and a video received from an external network, and the second video may be one of the prestored video, the video received from the external device and the video received from the external network.

The multi video generation apparatus may further include a video transmission module which transmits another video provided by the video provider to a display connected thereto.

The multi video generation apparatus may further include a video transmission module which transmits a third video provided by the video provider to a fifth display connected thereto and transmits a fourth video provided by the video provider to a sixth display connected thereto.

The number of the at least one video transmission module may be below the number of displays connected to the multi video generation apparatus.

The multi video generation apparatus may further include a plurality of slots which receive the video provided by the video provider. The at least one video transmission module may be attached to at least one of the plurality of slots, and may receive the video provided by the video provider.

The number of the plurality of slots may be above the number of the at least one video transmission module.

The number of the at least one video transmission module may be variable.

According to another aspect of the present invention, there is provided a multi video generation apparatus including a video provider which provides a video, a plurality of slots which receive the video provided by the video provider, and at least one video generation module which is attached to at least one of the plurality of slots and transmits the video provided by the video provider to a display connected thereto, wherein the number of the at least one video generation module is variable according to a content of a multi video to be displayed on the display.

The number of the at least one video generation module may be below the number of the plurality of slots.

The number of the at least one video generation module may be below the number of displays connected to the multi video generation apparatus.

The at least one video generation module may extract different portions of the video provided by the video provider, may generate different partial videos, and may transmit the generated partial videos to different displays connected thereto.

A first video generation module among the at least one video generation module may generate a partial video from the video provided by the video provider, and may transmit the generated partial video to a display connected thereto.

A second video generation module among the at least one video generation module may extract a first portion of the video provided by the video provider, may generate a first partial video, and may transmit the generated first partial video to a first display. Additionally, the second video generation module may extract a second portion of the video provided by the video provider, may generate a second partial video, and may transmit the generated second partial video to a second display.

A third video generation module among the at least one video generation module may generate a partial video from a first video provided by the video provider, may transmit the generated partial video to a third display, and may transmit a second video provided by the video provider to a fourth video.

The second video may be a video representing predetermined information with text.

The first video may be one of a broadcast video, a prestored video, a video received from an external device and a video received from an external network, and the second video may be one of the prestored video, the video received from the external device and the video received from the external network.

A fourth video generation module among the at least one video generation module may transmit a third video provided by the video provider to a fifth display connected thereto, and may transmit a fourth video provided by the video provider to a sixth display connected thereto.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view illustrating an example of a multivision system to which the present invention is applicable;

FIG. 2 is a view illustrating another example of a multivision system to which the present invention is applicable;

FIG. 3 is a block diagram illustrating a multi video generation apparatus according to an exemplary embodiment of the present invention;

FIG. 4 is a detailed block diagram illustrating a video transmission module shown in FIG. 3;

FIG. 5A is a view illustrating an example of a multi video;

FIG. 5B is a view illustrating a connection status of video transmission modules and a multivision in order to generate the multi video shown in FIG. 5A;

FIG. 6A is a view illustrating another example of a multi video;

FIG. 6B is a view illustrating a connection status of video transmission modules and a multivision in order to generate the multi video shown in FIG. 6A;

FIG. 7A is a view illustrating still another example of a multi video;

FIG. 7B is a view illustrating a connection status of video transmission modules and a multivision in order to generate the multi video shown in FIG. 7A;

FIG. 8A is a view illustrating yet another example of a multi video; and

FIG. 8B is a view illustrating a connection status of video transmission modules and a multivision in order to generate the multi video shown in FIG. 8A.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

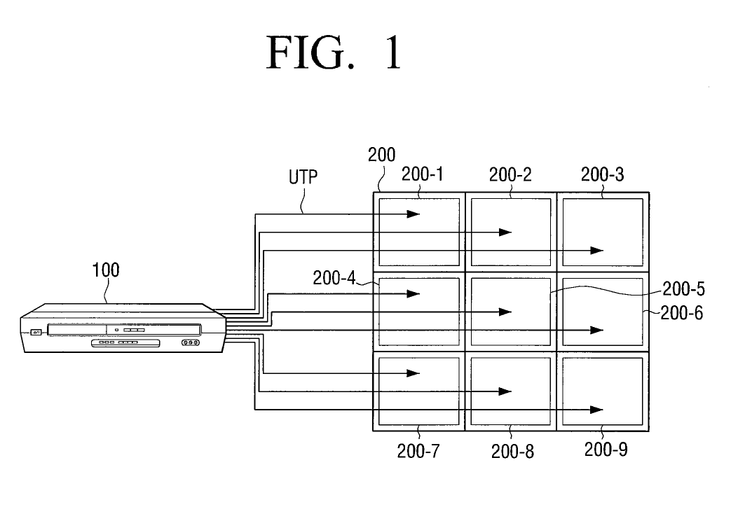

FIG. 1 is a view illustrating an example of a multivision system to which the present invention is applicable. As shown in FIG. 1, the multivision system includes a multi video generation apparatus 100 and a multivision 200.

The multivision 200 may be configured in such a manner that a plurality of displays are arranged and stacked in a desired form. The multivision 200 of FIG. 1 includes nine displays 200-1 to 200-9, which are arranged and stacked in three rows and three columns, but this is merely exemplary.

Herein, there is no limitation to the number of displays in the multivision 200 and to the arrangement and stack form of the displays. For example, 16 displays may be arranged and stacked in four rows and four columns to constitute the multivision 200. Additionally, the displays of the multivision 200 do not necessarily need to be arranged and stacked to form a rectangle. Thus, the displays may be arranged and stacked in various forms to constitute the multivision 200.

The multi video generation apparatus 100 generates a multi video and transmits the generated multi video to the multivision 200. The multi video refers to a collection of videos to be displayed on each of the displays 200-1 to 200-9 constituting the multivision 200.

In more detail, in the multivision system shown in FIG. 1, the multi video generated by the multi video generation apparatus 100 is a collection of video-1 to be displayed on a display 200-1, video-2 to be displayed on a display 200-2, video-3 to be displayed on a display 200-3, . . . , and video-9 to be displayed on a display 200-9.

The multi video generation apparatus 100 transfers the video-1 to video-9 forming the multi video to the displays 200-1 to 200-9, respectively. In more detail, the multi video generation apparatus 100 transfers the video-1 to the display 200-1, transfers the video-2 to the display 200-2, transfers the video-3 to the display 200-3, . . . , and transfers the video-9 to the display 200-9.

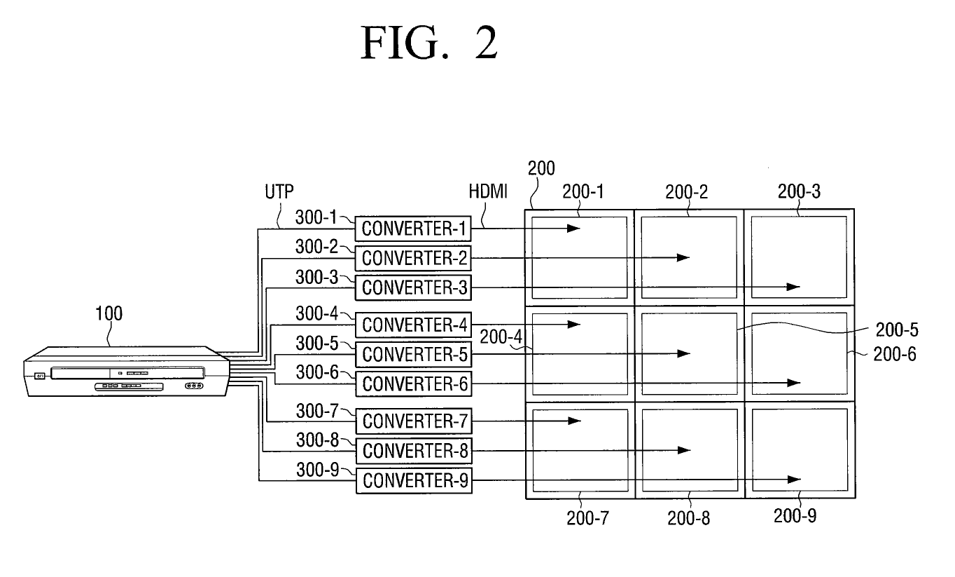

FIG. 2 is a view illustrating another example of a multivision system to which the present invention is applicable. The multivision system shown in FIG. 2 includes nine converters 300-1 to 300-9, in addition to the multi video generation apparatus 100 and the multivision 200.

The converters 300-1 to 300-9 convert a format of a video signal received from the multi video generation apparatus 100 into another format. In the multivision system shown in FIG. 2, the multi video generation apparatus 100 employs an ‘unshielded twisted pair (UTP) cable’ to output a video, whereas the multivision 200 employs a ‘high-definition multimedia interface (HDMI) cable’ to receive a video. That is, since different cables are used in the multivision system of FIG. 2, the multivision system of FIG. 2 requires the converters 300-1 to 300-9.

The converters 300-1 to 300-9 convert a video signal received via the UTP cable from the multi video generation apparatus 100 into an HDMI video signal, and transfer the HDMI video signal to the multivision 200 via the HDMI cable.

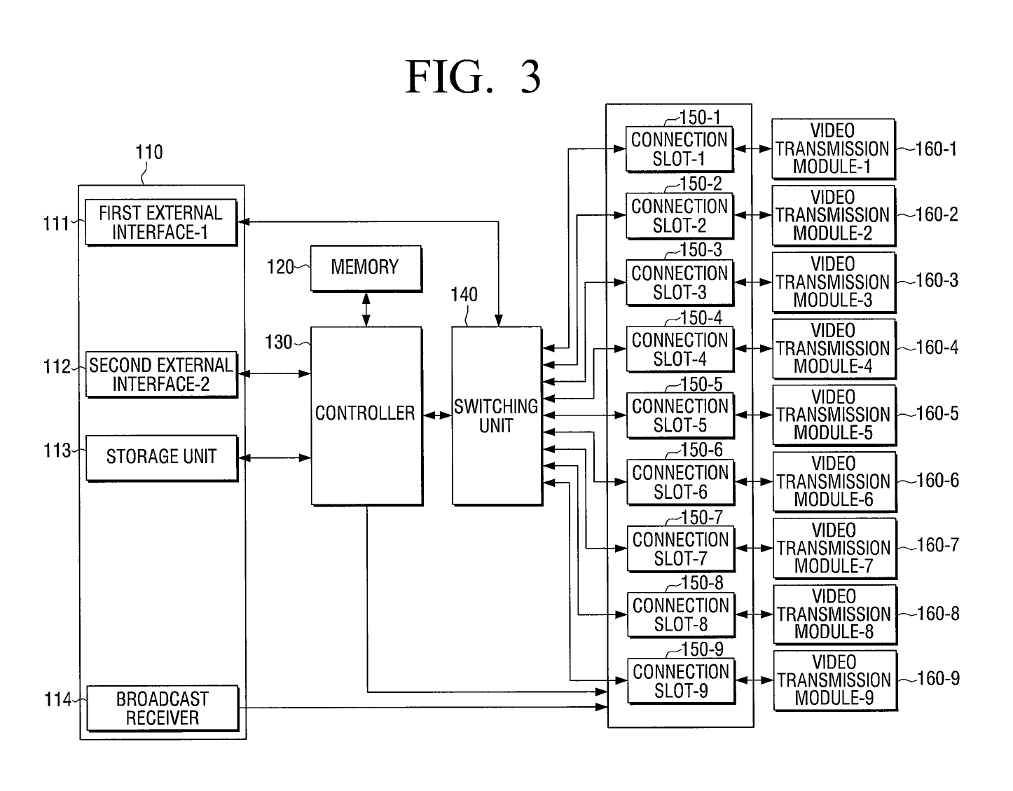

Hereinafter, the multi video generation apparatus 100 shown in FIGS. 1 and 2 is described in detail with reference to FIG. 3. FIG. 3 is a block diagram of the multi video generation apparatus 100 according to an exemplary embodiment of the present invention.

In FIG. 3, the multi video generation apparatus 100 includes a video provider 110, a memory 120, a controller 130, a switching unit 140, connection slots 150-1 to 150-9, and video transmission modules 160-1 to 160-9.

The video provider 110 functions to acquire videos from various sources. The video provider 110 functioning as described above includes a first external interface 111, a second external interface 112, a storage unit 113 and a broadcast receiver 114.

The first external interface 111 receives a video from an external device or an external network, and transfers the received video to the switching unit 140.

The second external interface 112 receives a video from an external device or an external network, in the same manner as the first external interface 111. However, the second external interface 112 transfers the received video to the controller 130, not to the switching unit 140. Thus, the second external interface 112 is distinct from the first external interface 111.

The controller 130 decodes an input video so that the input video is decompressed, which will be described below. Accordingly, the second external interface 112 may transfer the received video to the controller 130, so as to acquire a video required to be decoded. Additionally, the first external interface 111 may transfer the received video to the switching unit 140 directly, rather than the controller 130, so as to acquire a video which is not required to be decoded.

The storage unit 113 is a recording medium in which content is stored, and provides the stored content as a video. The video provided by the storage unit 113 is transferred to the controller 130.

The broadcast receiver 114 receives a broadcast video through radio waves or a cable, and provides the received broadcast video as a video. The video provided by the broadcast receiver 114 is transferred to the video transmission modules 160-1 to 160-9, which are attached to the connection slots 150-1 to 150-9.

The controller 130 decodes the video provided by the second external interface 112 and the video provided by the storage unit 113, so that the videos may be decompressed. Additionally, the controller 130 transfers the decompressed videos to the switching unit 140. The memory 120 provides a storage space, which is required when the controller 130 decodes videos.

The switching unit 140 performs a switching operation so that a video received from the first external interface 111 and a video received from the controller 130 may be selectively output to the video transmission modules 160-1 to 160-9 attached to the connection slots 150-1 to 150-9.

The switching operation of the switching unit 140 may be controlled by the controller 130. In more detail, the controller 130 may select videos to be transferred to the video transmission modules 160-1 to 160-9 from among the videos received to the switching unit 140. This operation will be described in detail below.

The connection slots 150-1 to 150-9 are connected to the video transmission modules 160-1 to 160-9, respectively. In more detail, a connection slot 150-1 is connected to a video transmission module 160-1, a connection slot 150-2 is connected to a video transmission module 160-2, a connection slot 150-3 is connected to a video transmission module 160-3, . . . , and a connection slot 150-9 is connected to a video transmission module 160-9.

The video transmission modules 160-1 to 160-9 extract some portions of the broadcast video received via the connection slots 150-1 to 150-9 from the broadcast receiver 114, to create partial videos. Additionally, the video transmission modules 160-1 to 160-9 transfer the created partial videos to the displays 200-1 to 200-9, respectively.

The video transmission modules 160-1 to 160-9 may also transfer videos received from the switching unit 140 through the connection slots 150-1 to 150-9 to the displays 200-1 to 200-9, respectively.

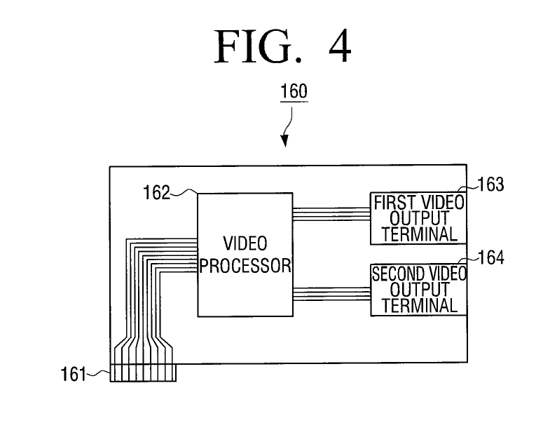

Hereinafter, the video transmission modules 160-1 to 160-9 are described in detail with reference to FIG. 4. Since the video transmission modules 160-1 to 160-9 have the same configuration, FIG. 4 illustrates a detailed block diagram of a video transmission module 160 which is representative of the video transmission modules 160-1 to 160-9.

In FIG. 4, the video transmission module 160 includes a slot connector 161, a video processor 162, a first video output terminal 163, and a second video output terminal 164.

The slot connector 161 may be inserted into the connection slots 150-1 to 150-9, so that the video transmission module 160 may be fixed into the connection slots 150-1 to 150-9. The video transmission module 160 may be electrically connected to the connection slots 150-1 to 150-9.

The video processor 162 decodes the broadcast video received from the broadcast receiver 114 through the connection slots 150-1 to 150-9 coupled to the slot connector 161, so that the broadcast video may be decompressed.

Additionally, the video processor 162 extracts a portion of the decompressed broadcast video as a partial video. In this situation, under the control of the controller 130, a portion to be extracted from the broadcast video by the video processor 162 may be determined.

The video processor 162 transfers the extracted partial video to a display connected to the first video output terminal 163 among the displays 200-1 to 200-9.

In this situation, the video processor 162 may output a video received from the switching unit 140 through the connection slots 150-1 to 150-9 coupled to the slot connector 161 to a display connected to the second video output terminal 164 among the displays 200-1 to 200-9.

In more detail, the video processor 162 may extract a portion of the broadcast video as a first partial video, may transfer the first partial video to the display connected to the first video output terminal 163, may extract another portion of the broadcast video as a second partial video, and may transfer the second partial video to the display connected to the second video output terminal 164.

Additionally, the video processor 162 may transfer the video received from the switching unit 140 to the display connected to the second video output terminal 164, may extract a portion of the broadcast video as a partial video, and may transfer the partial video to the display connected to the second video output terminal 164.

Alternatively, the video processor 162 may transfer one of the videos received from the switching unit 140 to the display connected to the first video output terminal 163, and may transfer another one of the videos received from the switching unit 140 to the display connected to the second video output terminal 164.

As described above, which display is to receive a video from the video transmission module 160 may be determined according to the connection status of the multi video generation apparatus 100 and the multivision 200. Additionally, according to the control of the controller 130, the video transmission module 160 may determine a video generation method and the type of video to be generated.

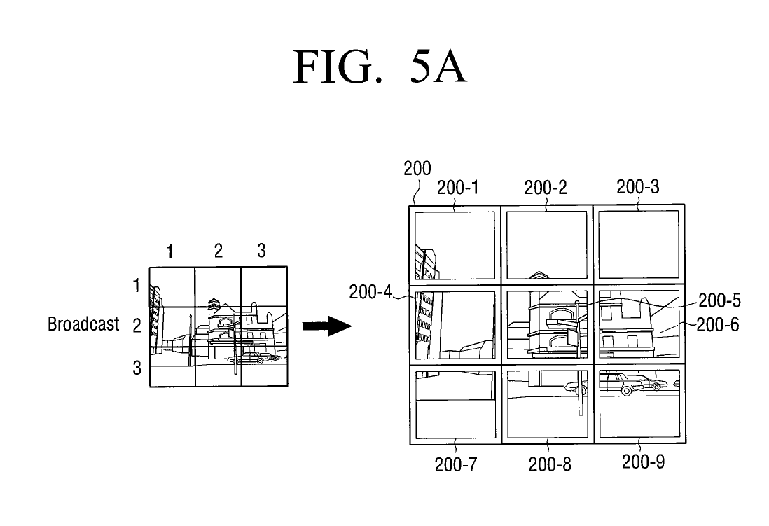

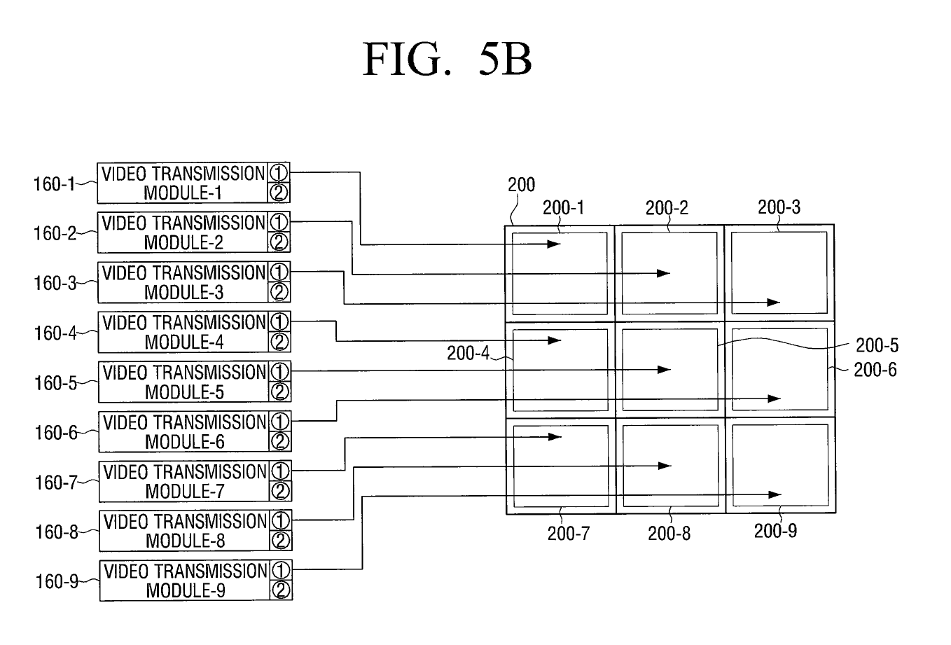

Hereinafter, various multi videos, which are generated by the multi video generation apparatus 100 to be displayed on the multivision 200, are exemplarily described in detail with reference to FIGS. 5A to 8B. Additionally, to implement these multi videos, the connection status of the multi video generation apparatus 100 and the multivision 200, and a control operation of the controller 130 are also described in detail.

FIG. 5A exemplarily illustrates a multi video displayed on the multivision 200. In FIG. 5A, the multi video includes nine partial videos into which a single broadcast video is divided. To realize the multi video of FIG. 5A, FIG. 5B illustrates the connection status of the multivision 200 and the video transmission modules 160-1 to 160-9 in the multi video generation apparatus 100.

“\textcircled{1}” and “\textcircled{2}” shown in FIG. 5B indicate the first video output terminal and the second video output terminal, respectively. That is, each of the video transmission modules 160-1 to 160-9 includes both the first video output terminal and the second video output terminal.

As shown in FIG. 5B, the first video output terminal of the video transmission module 160-1 is connected to the display 200-1, and the first video output terminal of the video transmission module 160-2 is connected to the display 200-2. Likewise, the first video output terminals of the video transmission modules 160-3 to 160-9 are connected to the displays 200-3 to 200-9, respectively.

To generate the multi video as shown in the right side of FIG. 5A, the controller 130 controls the video transmission modules 160-1 to 160-9. Herein, an ordered pair (x, y) may be used below to represent rows and columns of the broadcast video. In more detail, the controller 130 controls the video transmission module 160-1 to extract a partial video appearing on (1, 1) from the broadcast video so that the extracted partial video is output through the first video output terminal of the video transmission module 160-1. Additionally, the controller 130 controls the video transmission module 160-2 to extract a partial video appearing on (1, 2) from the broadcast video so that the extracted partial video is output through the first video output terminal of the video transmission module 160-2. The controller 130 also controls the video transmission module 160-3 to extract a partial video appearing on (1, 3) from the broadcast video so that the extracted partial video is output through the first video output terminal of the video transmission module 160-3. Likewise, the controller 130 controls the video transmission modules 160-4 to 160-9 to extract the other six partial videos from the broadcast video, so that the extracted partial videos are output through the first video output terminals of the video transmission modules 160-4 to 160-9, respectively.

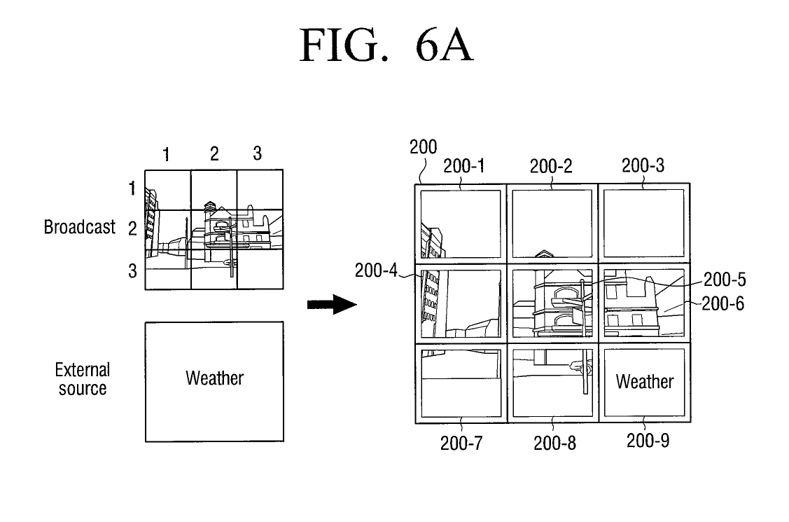

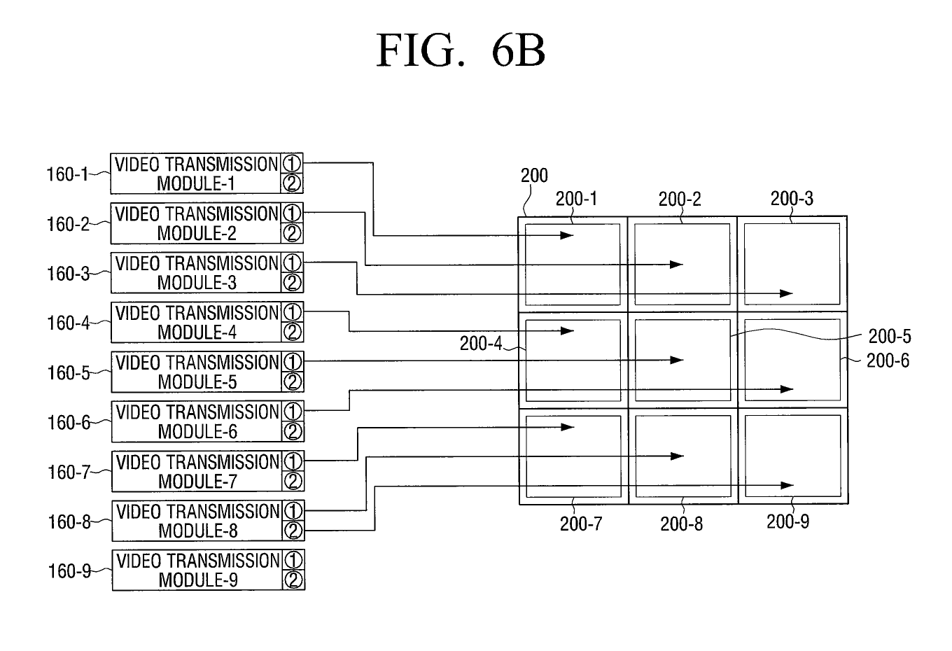

FIG. 6A exemplarily illustrates a multi video displayed on the multivision 200. In FIG. 6A, the multi video includes eight partial videos among nine partial videos into which a single broadcast video is divided, and a ‘weather information video received from an external source.’

The ‘weather information video’ may be video or text representing information regarding weather. ‘Traffic information video,’ ‘clock video,’ and ‘news video’ that will be described below may also be video or text. Text representing information regarding weather occupies less storage space than video.

To realize the multi video of FIG. 6A, FIG. 6B illustrates the connection status of the multivision 200 and the video transmission modules 160-1 to 160-9 in the multi video generation apparatus 100.

As shown in FIG. 6B, the first video output terminal of the video transmission module 160-1 is connected to the display 200-1, and the first video output terminal of the video transmission module 160-2 is connected to the display 200-2. Likewise, the first video output terminals of the video transmission modules 160-3 to 160-8 are connected to the displays 200-3 to 200-8, respectively. Additionally, the second video output terminal of the video transmission module 160-8 is connected to the display 200-9, and the video transmission module 160-9 is not used.

To generate the multi video as shown in the right side of FIG. 6A, the controller 130 controls the video transmission module 160-1 to extract a partial video appearing on (1, 1) from the broadcast video so that the extracted partial video is output through the first video output terminal of the video transmission module 160-1. Additionally, the controller 130 controls the video transmission module 160-2 to extract a partial video appearing on (1, 2) from the broadcast video so that the extracted partial video is output through the first video output terminal of the video transmission module 160-2. The controller 130 also controls the video transmission module 160-3 to extract a partial video appearing on (1, 3) from the broadcast video so that the extracted partial video is output through the first video output terminal of the video transmission module 160-3. Likewise, the controller 130 controls the video transmission modules 160-4 to 160-8 to extract the other five partial videos from the broadcast video, so that the extracted partial videos are output through the first video output terminals of the video transmission modules 160-4 to 160-8, respectively. In addition, the controller 130 controls the video transmission module 160-8 so that the weather information video is output through the second video output terminal of the video transmission module 160-8.

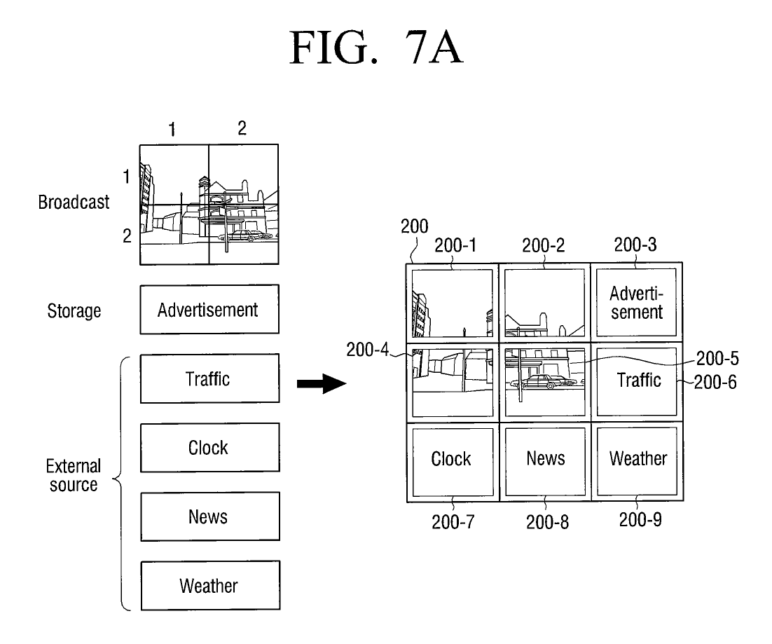

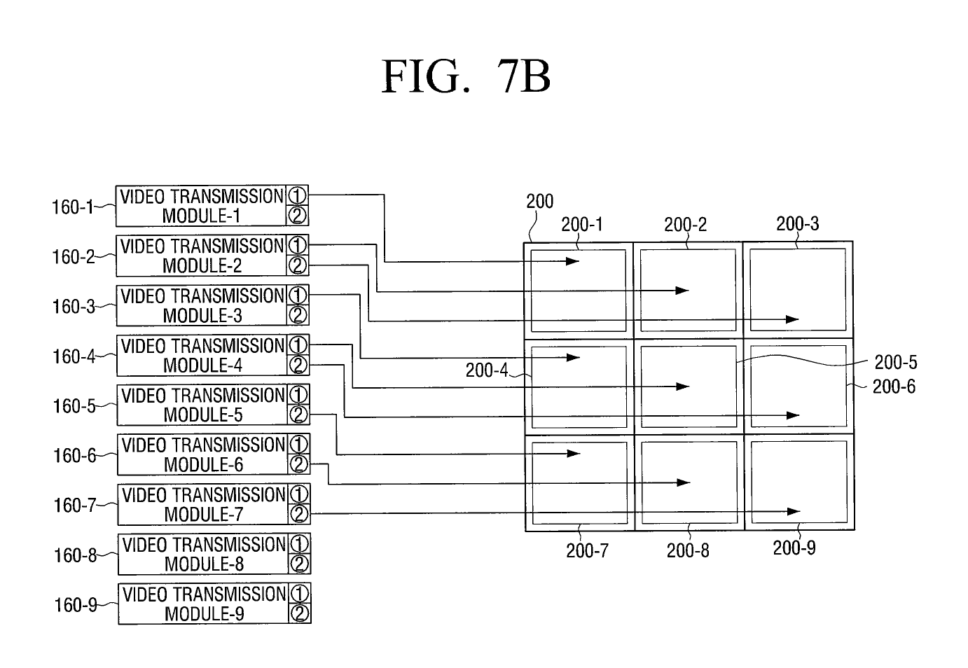

FIG. 7A exemplarily illustrates a multi video displayed on the multivision 200. In FIG. 7A, the multi video includes four partial videos into which a single broadcast video is divided, a prestored advertisement video, a traffic information video received from an external source, a clock video received from an external source, a news video received from an external source, and a weather information video received from an external source.

To realize the multi video of FIG. 7A, FIG. 7B illustrates the connection status of the multivision 200 and the video transmission modules 160-1 to 160-9 in the multi video generation apparatus 100.

As shown in FIG. 7B, the first video output terminal of the video transmission module 160-1 is connected to the display 200-1, and the first video output terminal and second video output terminal of the video transmission module 160-2 are connected to the displays 200-2 and 200-3, respectively. The first video output terminal of the video transmission module 160-3 is connected to the fourth display 200-4, and the first video output terminal and second video output terminal of the video transmission module 160-4 are connected to the displays 200-5 and 200-6, respectively. The second video output terminal of the video transmission module 160-5 is connected to the display 200-7, and the second video output terminal of the video transmission module 160-6 is connected to the display 200-8. The second video output terminal of the video transmission module 160-7 is connected to the display 200-9, and the video transmission module 160-8 and the video transmission module 160-9 are not used.

To generate the multi video as shown in the right side of FIG. 7A, the controller 130 controls the video transmission module 160-1 to extract a partial video appearing on (1, 1) from the broadcast video so that the extracted partial video is output through the first video output terminal of the video transmission module 160-1. Additionally, the controller 130 controls the video transmission module 160-2 to extract a partial video appearing on (1, 2) from the broadcast video, so that the extracted partial video and prestored advertisement video are output through the first video output terminal and second video output terminal of the video transmission module 160-2, respectively. Furthermore, the controller 130 controls the video transmission module 160-3 to extract a partial video appearing on (2, 1) from the broadcast video so that the extracted partial video is output through the first video output terminal of the video transmission module 160-3. Moreover, the controller 130 controls the video transmission module 160-4 to extract a partial video appearing on (2, 2) from the broadcast video, so that the extracted partial video and traffic information video are output through the first video output terminal and second video output terminal of the video transmission module 160-4, respectively. Likewise, the controller 130 controls the video transmission modules 160-5 to 160-7, so that the clock video, the news video and the weather information video are output through the second video output terminals of the video transmission modules 160-5 to 160-7, respectively.

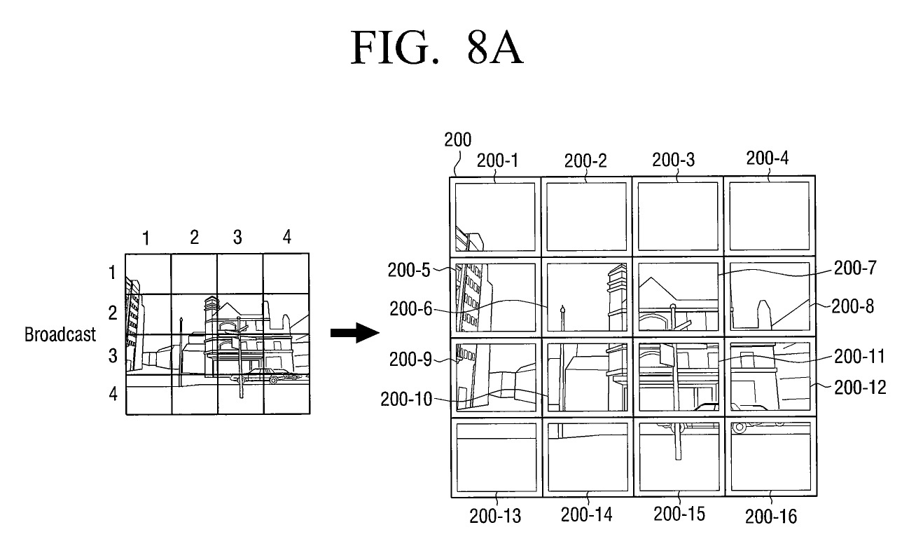

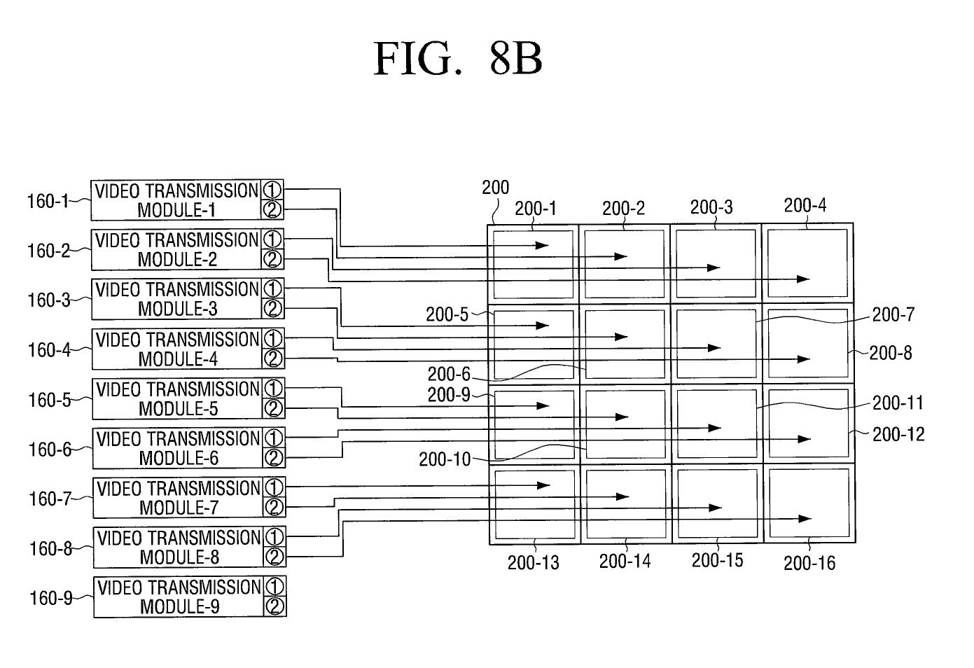

FIG. 8A exemplarily illustrates a multi video displayed on the multivision 200. In FIG. 8A, the multi video includes 16 partial videos into which a single broadcast video is divided. To realize the multi video of FIG. 8A, FIG. 8B illustrates the connection status of the multivision 200 and the video transmission modules 160-1 to 160-9 in the multi video generation apparatus 100.

As shown in FIG. 8B, the first video output terminal and second video output terminal of the video transmission module 160-1 are connected to the displays 200-1 and 200-2, respectively. The first video output terminal and second video output terminal of the video transmission module 160-2 are connected to the displays 200-3 and 200-4, respectively. In the same manner, the first video output terminals of the video transmission modules 160-3 to 160-8 are connected to the displays 200-5, 200-7, 200-9, 200-11, 200-13, 200-15, respectively, and the second video output terminals of the video transmission modules 160-3 to 160-8 are connected to the displays 200-6, 200-8, 200-10, 200-12, 200-14, 200-16, respectively. In this situation, the video transmission module 160-9 is not used.

To generate the multi video as shown in the right side of FIG. 8A, the controller 130 controls the video transmission module 160-1 to extract a partial video appearing on (1, 1) and a partial video appearing on (1, 2) from the broadcast video, so that the partial video at (1, 1) and partial video at (1, 2) are output through the first video output terminal and second video output terminal of the video transmission module 160-1, respectively. Additionally, the controller 130 controls the video transmission module 160-2 to extract a partial video appearing on (1, 3) and a partial video appearing on (1, 4) from the broadcast video, so that the partial video at (1, 3) and partial video at (1, 4) are output through the first video output terminal and second video output terminal of the video transmission module 160-2, respectively.

Likewise, the controller 130 controls the video transmission modules 160-3 to 160-8 to extract the other partial videos from the broadcast video, so that the extracted partial videos are output through the first video output terminals and second video output terminals of the video transmission modules 160-4 to 160-9, respectively.

Various multi videos which are generated by the multi video generation apparatus 100 to be displayed on the multivision 200 have been exemplarily described above. Additionally, to implement these multi videos, the connection status of the multi video generation apparatus 100 and the multivision 200, and a control operation of the controller 130 have also been described above in detail.

The broadcast video is divided and displayed on the multivision 200 and videos other than the broadcast video are displayed on the multivision 200 without any change in the exemplary embodiments of the present invention, but this is merely exemplary for convenience of description.

Accordingly, videos other than the broadcast video may be divided and displayed on the multivision 200, and the broadcast video may be displayed on the multivision 200 without being divided.

Additionally, the broadcast video may be output through either the first video output terminals or the second video output terminals, and videos other than the broadcast video may be output through only the second video output terminals in the exemplary embodiments of the present invention, but this is merely exemplary for convenience of description. Accordingly, videos other than the broadcast video may also be output through the first video output terminals.

As described above, according to exemplary embodiments of the present invention, a multi video generation apparatus may generate partial videos using video transmission modules and may transmit the generated partial videos to displays constituting a multivision, and thus it is possible to generate more diverse types of multi video which a user desires to display on the multivision.

Additionally, according to these exemplary embodiments of the present invention, it is possible to change the number of modules for generating a video to be transmitted to the displays of the multivision. Accordingly, it is possible to simply change the configuration of the multi video generation apparatus according to content of a multi video to be displayed on the multivision. In addition, only necessary modules may be mounted in the multi video generation apparatus, and thus it is possible to enhance economic efficiency.

Furthermore, when a user desires to change a multi video to be displayed on the multivision, there is no need for the user to move to a location where the multivision is placed, and thus it is possible to easily manage the multivision and to reduce management costs. Moreover, the configuration of the multi video generation apparatus may be simplified, which may make it possible to reduce system manufacturing costs.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A multi video generation apparatus comprising:
a video provider which provides a video; and
at least one video transmission module which generates a partial video from the video provided by the video provider, and transmits the generated partial video to a display connected thereto.

2. The multi video generation apparatus as claimed in claim 1, wherein the at least one video transmission module extracts different portions of the video provided by the video provider, generates different partial videos, and transmits the generated partial videos to different displays connected thereto.

3. The multi video generation apparatus as claimed in claim 1, wherein a first video transmission module among the at least one video transmission module extracts a first portion of the video provided by the video provider, generates a first partial video, and transmits the generated first partial video to a first display, and
the first video transmission module extracts a second portion of the video provided by the video provider, generates a second partial video, and transmits the generated second partial video to a second display.

4. The multi video generation apparatus as claimed in claim 1, wherein a second video transmission module among the at least one video transmission module generates a partial video from a first video provided by the video provider, transmits the generated partial video to a third display, and transmits a second video provided by the video provider to a fourth display.

5. The multi video generation apparatus as claimed in claim 4, wherein the second video is a video representing predetermined information with text.

6. The multi video generation apparatus as claimed in claim 4, wherein the first video is one of a broadcast video, a prestored video, a video received from an external device and a video received from an external network, and
the second video is one of the prestored video, the video received from the external device and the video received from the external network.

7. The multi video generation apparatus as claimed in claim 1, wherein the number of the at least one video transmission module is below the number of displays connected to the multi video generation apparatus.

8. The multi video generation apparatus as claimed in claim 1, further comprising:
a plurality of slots which receive the video provided by the video provider,
wherein the at least one video transmission module is attached to at least one of the plurality of slots, and receives the video provided by the video provider.

9. The multi video generation apparatus as claimed in claim 8, wherein the number of the plurality of slots is above the number of the at least one video transmission module.

10. The multi video generation apparatus as claimed in claim 1, wherein the number of the at least one video transmission module is variable.

11. A multi video generation apparatus comprising:
a video provider which provides a video;
a plurality of slots which receive the video provided by the video provider; and
at least one video generation module which is attached to at least one of the plurality of slots and transmits the video provided by the video provider to a display connected thereto,
wherein the number of the at least one video generation module is variable according to a content of a multi video to be displayed on the display.

12. The multi video generation apparatus as claimed in claim 11, wherein the number of the at least one video generation module is below the number of the plurality of slots.

13. The multi video generation apparatus as claimed in claim 11, wherein the number of the at least one video generation module is below the number of displays connected to the multi video generation apparatus.

14. The multi video generation apparatus as claimed in claim 11, wherein the at least one video generation module extracts different portions of the video provided by the video provider, generates different partial videos, and transmits the generated partial videos to different displays connected thereto.

15. The multi video generation apparatus as claimed in claim 11, wherein a first video generation module among the at least one video generation module generates a partial video from the video provided by the video provider, and transmits the generated partial video to a display connected thereto.

16. The multi video generation apparatus as claimed in claim 11, wherein a second video generation module among the at least one video generation module extracts a first portion of the video provided by the video provider, generates a first partial video, and transmits the generated first partial video to a first display, and
the second video generation module extracts a second portion of the video provided by the video provider, generates a second partial video, and transmits the generated second partial video to a second display.

17. The multi video generation apparatus as claimed in claim 11, wherein a third video generation module among the at least one video generation module generates a partial video from a first video provided by the video provider, transmits the generated partial video to a third display, and transmits a second video provided by the video provider to a fourth video.

18. The multi video generation apparatus as claimed in claim 17, wherein the second video is a video representing predetermined information with text.

19. The multi video generation apparatus as claimed in claim 17, wherein the first video is one of a broadcast video, a prestored video, a video received from an external device and a video received from an external network, and
the second video is one of the prestored video, the video received from the external device and the video received from the external network.

20. The multi video generation apparatus as claimed in claim 11, wherein a fourth video generation module among the at least one video generation module transmits a third video provided by the video provider to a fifth display connected thereto, and transmits a fourth video provided by the video provider to a sixth display connected thereto.
